(19) United States
(12) Patent Application Publication
(10) Pub. No.: US 2020/0033613 A1
(43) Pub. Date: Jan. 30, 2020

(54) DISPLAY APPARATUS AND METHOD OF DISPLAYING USING CURVED OPTICAL COMBINER

(71) Applicant: Varjo Technologies Oy, Helsinki (FI)

(72) Inventors: Urho Konttori, Helsinki (FI); Evgeny Shirko, Saint-Petersburg (RU); Klaus Melakari, Oulu (FI)

(21) Appl. No.: 16/046,486

(22) Filed: Jul. 26, 2018

(51) Int. Cl. G02B 27/10; G02B 27/14; G02B 27/12; G09G 3/00

(52) U.S. Cl. CPC G02B 27/1066; G09G 3/002; G02B 27/126; G02B 27/144

(57) ABSTRACT

Disclosed is a display apparatus including first display having first display resolution, that is to be employed for displaying first image; second display having second display resolution, that is to be employed for displaying second image; exit optical element; and optical combiner to optically combine projections of the first and second images. The optical combiner includes first optical element having a reflective surface obliquely facing the exit optical element having an outwardly-curved shape.

### TECHNICAL FIELD

The present disclosure relates generally to representation of visual information; and more specifically, to display apparatuses comprising displays and optical combiners. Furthermore, the present disclosure also relates to methods of displaying via the aforementioned display apparatuses.

### BACKGROUND

Nowadays, several technologies are being used to present interactive simulated environments to users of specialized devices. Such technologies include virtual reality, augmented reality, mixed reality, and the like. Presently, the users utilize the specialized devices (for example, such as virtual reality headsets, a pair of virtual reality glasses, augmented reality headsets, a pair of augmented reality glasses, mixed reality headsets, a pair of mixed reality glasses, and the like) for experiencing and interacting with such simulated environments. Specifically, the simulated environments enhance the user's experience of reality around him/her by providing the user with a feeling of immersion within the simulated environment, using contemporary techniques such as stereoscopy.

Generally, the specialized devices include displays arranged therein, whereupon images of a visual scene within a given simulated environment are rendered. Generally, such devices cover an entire viewing angle of the user's eye. For example, such specialized devices may employ microdisplays for displaying different views (for example, such as a left perspective view and a right perspective view) of a given scene within the given simulated environment to the user's eyes. Such different views that are rendered using two-dimensional microdisplays allow the user to perceive stereoscopic depth (namely, three-dimensional depth) within the given scene, thereby, creating the feeling of immersion within the simulated environment. Examples of such microdisplays include, but are not limited to, Liquid Crystal microdisplays, Light Emitting Diode-based microdisplays, Organic Light Emitting Diode-based microdisplays and Liquid Crystal on Silicon-based microdisplays.

However, conventional specialized devices employing such microdisplays have certain limitations associated therewith. Firstly, there exists a trade-off between power consumption and resolution in some existing microdisplays. As an example, power consumption of Liquid Crystal microdisplays having high resolution, is substantially high. Secondly, the microdisplays are often difficult to manufacture owing to immature manufacturing techniques. As a result, even when manufacturing volumes are high, the microdisplays are expensive. Furthermore, the microdisplays having sufficient resolution (such as 2K*2K resolution) are generally known to have a short lifetime. Therefore, use of the microdisplays in the aforesaid specialized devices is cost ineffective. Thirdly, some existing microdisplays suffer from low brightness, and are thereby unable to display the visual scene efficiently. Therefore, the specialized devices employing such microdisplays are unable to truly provide the user with the feeling of immersion within the simulated environment.

Therefore, in light of the foregoing discussion, there exists a need to overcome the aforementioned drawbacks associated with conventional specialized devices employing microdisplays.

### SUMMARY

The present disclosure seeks to provide a display apparatus comprising at least one first display, at least one second display, at least one exit optical element and at least one optical combiner. The present disclosure also seeks to provide a method of displaying, via such a display apparatus. The present disclosure seeks to provide a solution to the existing problems such as a trade-off between power consumption and resolution, immature manufacturing techniques and low brightness that are associated with existing microdisplays to be employed in specialized devices. An aim of the present disclosure is to provide a solution that overcomes at least partially the problems encountered in prior art, and provides power-efficient, near human-eye resolution, cost-effective and compact display apparatuses.

In one aspect, an embodiment of the present disclosure provides a display apparatus comprising:
at least one first display having a first display resolution, wherein the at least one first display is to be employed for displaying a first image;
at least one second display having a second display resolution, wherein the at least one second display is to be employed for displaying a second image;
at least one exit optical element; and
at least one optical combiner to be employed to optically combine a projection of the first image with a projection of the second image, the at least one optical combiner comprising a first optical element having a reflective surface obliquely facing the at least one exit optical element, the reflective surface having an outwardly-curved shape.

In another aspect, an embodiment of the present disclosure provides a method of displaying, via a display apparatus comprising at least one first display having a first display resolution, at least one second display having a second display resolution, at least one exit optical element and at least one optical combiner, the at least one optical combiner comprising a first optical element having a reflective surface obliquely facing the at least one exit optical element, the reflective surface having an outwardly-curved shape, the method comprising:
displaying a first image and a second image, via the at least one first display and the at least one second display, substantially simultaneously; and
arranging the first optical element in a manner that a projection of the first image and a projection of the second image are optically combined.

Embodiments of the present disclosure substantially eliminate or at least partially address the aforementioned problems in the prior art, and enable provision of a simulated environment to a user, via display apparatuses having power-efficient, near human-eye resolution and cost-effective displays.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B illustrate block diagrams of architectures of a display apparatus, in accordance with different embodiments of the present disclosure;

FIGS. 2A and 2B illustrate exemplary implementations of a display apparatus, in accordance with different embodiments of the present disclosure;

FIG. 2C illustrates an isometric view of an optical combiner for use in a display apparatus, in accordance with an embodiment of the present disclosure;

FIGS. 3A and 3B illustrate exemplary implementations of a display apparatus, in accordance with different embodiments of the present disclosure; and

FIG. 4 illustrates steps of a method of displaying, via a display apparatus, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a display apparatus comprising:
at least one first display having a first display resolution, wherein the at least one first display is to be employed for displaying a first image;
at least one second display having a second display resolution, wherein the at least one second display is to be employed for displaying a second image;
at least one exit optical element; and
at least one optical combiner to be employed to optically combine a projection of the first image with a projection of the second image, the at least one optical combiner comprising a first optical element having a reflective surface obliquely facing the at least one exit optical element, the reflective surface having an outwardly-curved shape.

In another aspect, an embodiment of the present disclosure provides a method of displaying, via a display apparatus comprising at least one first display having a first display resolution, at least one second display having a second display resolution, at least one exit optical element and at least one optical combiner, the at least one optical combiner comprising a first optical element having a reflective surface obliquely facing the at least one exit optical element, the reflective surface having an outwardly-curved shape, the method comprising:
displaying a first image and a second image, via the at least one first display and the at least one second display, substantially simultaneously; and
arranging the first optical element in a manner that a projection of the first image and a projection of the second image are optically combined.

The present disclosure provides the aforementioned display apparatus and the aforementioned method of displaying, via such a display apparatus. The display apparatus allows for emulating optical properties (for example, such as foveation) of the human visual system. Notably, manufacturing costs associated with displays employed in the aforesaid display apparatus are lesser as compared to manufacturing costs associated with existing microdisplays. Furthermore, the displays employed in the aforesaid display apparatus provide an optimal trade-off between power consumption and resolution. Therefore, the first and second displays employed in the aforesaid display apparatus are cost efficient. Beneficially, the aforesaid display apparatus is compact and lightweight.

Optionally, the at least one first display and the at least one second display are manufactured using a same technology. As an example, the at least one first display and the at least one second display may be implemented by way of Liquid Crystal Displays (LCD's) that have been manufactured in a same batch. This potentially provides advantages related to color similarity and maximum attainable frame rate, thereby allowing easy color calibration and blending of the aforesaid displays and tuning the performance.

Throughout the present disclosure, the term “display apparatus” used herein relates to specialized equipment that is configured to display a visual scene of a simulated environment to a user of the display apparatus when the display apparatus is worn by the user on his/her head. In such an instance, the display apparatus is operable to act as a device (for example, such as a virtual reality headset, an augmented reality headset, a mixed reality headset, a pair of virtual reality glasses, a pair of augmented reality glasses, a pair of mixed reality glasses and so forth) for presenting the simulated environment to the user.

As mentioned previously, the display apparatus comprises the at least one first display having the first display resolution, wherein the at least one first display is to be employed for displaying the first image. Throughout the present disclosure, the term “first display” used herein relates to equipment (for example, such as a display screen) that is configured to facilitate displaying of the first image thereupon. When the first image is displayed upon the at least one first display, the projection of the first image emanates from the at least one first display. Optionally, the at least one first display is selected from the group consisting of: a Liquid Crystal Display (LCD), a Light Emitting Diode (LED)-based display, an Organic LED (OLED)-based display, a micro OLED-based display, and a Liquid Crystal on Silicon (LCoS)-based display.

Throughout the present disclosure, the term “projection” refers to a collection of light rays emanating from a display when an image is displayed thereat. A projection of a given image (namely, the collection of light rays) may transmit through and/or reflect from various optical elements of the display apparatus before reaching the user's eye. For purposes of embodiments of the present disclosure, the term “projection” has been used consistently, irrespective of whether the collection of light rays is transmitted or reflected.

Furthermore, the display apparatus comprises the at least one second display having the second display resolution, wherein the at least one second display is to be employed for displaying the second image. Throughout the present disclosure, the term “second display” used herein relates to equipment (for example, such as a display screen) that is configured to facilitate displaying of the second image thereupon. When the second image is displayed upon the at least one second display, the projection of the second image emanates from the at least one second display. Optionally, the at least one second display is selected from the group consisting of: a Liquid Crystal Display (LCD), a Light Emitting Diode (LED)-based display, an Organic LED (OLED)-based display, a micro OLED-based display, and a Liquid Crystal on Silicon (LCoS)-based display.

It will be appreciated that the at least one first display and the at least one second display can be manufactured easily and cost-effectively, via existing manufacturing techniques. Notably, the at least one first display and the at least one second display can be manufactured at much lower cost as compared to existing microdisplays.

It will be appreciated that the first image and the second image collectively constitute an image depicting the visual scene that is to be presented to the user, via the display apparatus. Therefore, the “first image” and the “second image” can be understood to relate to a first portion and a second portion of the image depicting the visual scene, respectively. The sizes of the first portion and the second portions of the image may be equal or unequal.

Optionally, the first image relates to a substantially-large portion of the image depicting the visual scene, whereas the second image relates to a substantially-small portion of the image depicting the visual scene. In other words, a size (namely, dimensions) of the second image is relatively smaller as compared to a size (namely, dimensions) of the first image.

In an embodiment, the second image substantially corresponds to a central portion of the image depicting the visual scene whereas the first image substantially corresponds to a peripheral portion of the image depicting the visual scene.

In another embodiment, the second image substantially corresponds to a portion of the image depicting the visual scene whereat the user's gaze is focused, whereas the first image substantially corresponds to a remaining portion of the image depicting the visual scene. Therefore, the first image may be referred to as a “context image” whereas the second image may be referred to as a “focus image”. In such a case, the at least one first display is to be employed for displaying the context image and the at least one second display is to be employed for displaying the focus image. Therefore, the at least one first display may be referred to as “at least one context display” and the at least one second display may be referred to as “at least one focus display”.

Throughout the present disclosure, the term “display resolution” of a given display relates to pixel density (namely, pixels per unit area) within the given display. Notably, “display resolution” relates to a spatial resolution of pixels of the given display. Furthermore, the second display resolution can be lesser than, equal to, or greater than the first display resolution. It will be appreciated that irrespective of magnitudes of the first and second display resolutions, an apparent angular resolution of the second image is higher than an apparent angular resolution of the first image, when the first and second images are viewed by the user of the display apparatus. Therefore, when the second image is projected by the display apparatus on and around the fovea of the user's eye and the first image is projected by the display apparatus upon a remaining region of the retina of the user's eye, such apparent angular resolutions (namely, pixels per degree) of the first and second images allow for the display apparatus to emulate foveation properties of the human visual system.

In one example, the second display resolution may be lower than or equal to the first display resolution. In such an example, pixels per unit area of the at least one second display may be lesser than or equal to pixels per unit area of the at least one first display. As a result, the second image is originally displayed at a lower or same resolution as compared to the first image.

In another example, the second display resolution may be greater than the first display resolution. In such an example, the second image is originally displayed at a greater resolution than the first image.

It will be appreciated that the first and second displays employed within the display apparatus provide an optimal trade-off between power consumption and resolution. In other words, the first and second display resolutions of the first and second displays are sufficiently high for emulating near human-eye resolution, without consuming abnormal (or excessive) amounts of power for their operation.

Optionally, an angular width of the projection of the first image is greater than an angular width of the projection of the second image. The term “angular width” used herein relates to an angular width of a given projection as seen from the user's eye, when the display apparatus is worn by the user. It will be appreciated that the angular width of the projection of the first image is greater than the angular width of the projection of the second image, since the second image is to be typically projected on and around the fovea of the user's eye, whereas the first image is to be typically projected upon the retina of the user's eye.

Optionally, the angular width of the projection of the first image ranges from 40 degrees to 220 degrees, whereas the angular width of the projection of the second image ranges from 5 degrees to 60 degrees. More optionally, the angular width of the projection of the first image ranges from 80 to 120 degrees, whereas the angular width of the projection of the second image ranges from 25 to 50 degrees. In some implementations, the angular width of the projection of the first image may be for example, such as 80, 85, 90, 95, 100, 105, 110, 115 or 120 degrees, whereas the angular width of the projection of the second image may be for example, such as 25, 30, 35, 40, 45 or 50 degrees.

In an exemplary implementation, the display apparatus comprises one first display and one second display per eye of the user. In such a case, separate first images and separate second images for a left eye and a right eye of the user are displayed using the separate first displays and the separate second displays for the left eye and the right eye, respectively. The separate first images for the left eye and the right eye of the user collectively constitute the first image, whereas the separate second images for the left eye and the right eye of the user collectively constitute the second image.

In another exemplary implementation, the display apparatus comprises a single first display and a single second display for both eyes of the user, on a shared basis. In such a case, the single first display and the single second display are used to render the separate first images and the separate second images for both the left eye and the right eye of the user, respectively, on a shared basis.

Optionally, the size of the at least one first display is substantially similar to the size of the at least one second display. In such a case, the size of the first image (that is displayed upon the at least one first display) is substantially similar to the size of the second image (that is displayed upon the at least one second display). Alternatively, optionally, the size of the at least one second display is lesser as compared to the size of the at least one first display. In such a case, the size of the second image (that is to be displayed upon the at least one second display) is smaller as compared to the size of the first image (that is to be displayed upon the at least one first display).

It will be appreciated that the sizes of the at least one first display and the at least one second display are chosen such that the at least one first display and the at least one second display can be compactly arranged within the display apparatus. As a result, the size and weight of the display apparatus can be substantially reduced.

Optionally, the size of the at least one first display and/or the at least one second display ranges between 1.4 inch and 4 inch, when measured diagonally. In other words, a distance between diagonal points of the at least one first display and/or the at least one second display ranges between 1.4 inch and 4 inch. In an example, the size of the at least one first display and/or the at least one second display, when measured diagonally, may be 1.4, 1.5, 1.6, 1.7, 1.8, 1.9, 2, 2.4, 2.6, 2.8, 3, 3.2, 3.4, 3.6, 3.8 or 4 inch.

Alternatively optionally, the size of the at least one first display and/or the at least one second display is lesser than 1.4 inch or greater than 4 inch, when measured diagonally. In an example, the size of the at least one first display and/or the at least one second display, when measured diagonally, may be 1, 1.1, 1.2, 1.3 or 1.4 inch. In such a case, the display apparatus may further comprise magnifying optics (such as enlarging lenses) to increase an apparent size of the first and second images displayed upon the at least one first display and/or the at least one second display, from a perspective of the user's eye. In another example, the size of the at least one first display and/or the at least one second display, when measured diagonally, may be 4, 4.2, 4.4, 4.6, 4.8, 5, 5.2, 5.4, 5.6, 5.8 or 6 inch.

As mentioned previously, the display apparatus also comprises the at least one exit optical element. Throughout the present disclosure, the term “exit optical element” relates to an optical device configured to direct the projection of the first image and the projection of the second image, towards the user's eye, when the display apparatus is worn by the user. Furthermore, the term “exit optical element” may also be referred to as an “eyepiece”.

Optionally, the at least one exit optical element receives the projection of the first image and the projection of the second image and modifies an optical path and/or optical characteristics of the aforesaid projections, prior to directing the aforesaid projections towards the user's eye. In one example, the at least one exit optical element may magnify a size (or angular dimensions) of the projection of the first image. In such a case, use of a magnifying exit optical element allows for use of dimensionally small components within the display apparatus.

Furthermore, optionally, the at least one exit optical element is implemented by way of a lens. It will be appreciated that such a lens can be categorized based upon its shape, for example, such as a convex lens, a plano-convex lens, a Fresnel lens, an aspherical lens, an achromatic lens, a meniscus lens, a nano-grating lens and the like. Moreover, such lenses can be manufactured using various suitable materials, for example, such as glass, plastic, polycarbonate materials, active polymers, flexible membranes and the like. Examples of such a lens include, but are not limited to, Liquid-crystal (LC) lens and a liquid lens.

Optionally, the at least one exit optical element has a curved surface facing the user's eye. In such an instance, the curved surface may be convex (namely, bulging outwardly towards the user's eye) or concave (namely, bulging inwards, away from the user's eye).

Optionally, the size of the at least one exit optical element ranges between 20 mm and 60 mm. In other words, a dimension (for example, the diameter) of the at least one exit optical element optionally ranges between 20 mm and 60 mm. It will be appreciated that the size of the at least one exit optical element is selected to be one that allows the projection of the first image and the projection of the second image to properly pass therethrough. In an example, the diameter of the at least one exit optical element may be, for example, 20, 25, 30, 35, 40, 45, 50, 55 or 60 mm.

Furthermore, the display apparatus comprises the at least one optical combiner that is to be employed to optically combine the projection of the first image with the projection of the second image. Throughout the present disclosure, the term “optical combiner” used herein relates to equipment (for example, such as optical elements) for optically combining the projection of the first image and the projection of the second image. In operation, the at least one optical combiner optically combines the projections of the first and second images to constitute a combined projection, wherein the combined projection is a projection of the image depicting the visual scene. Therefore, when the display apparatus is worn and used by the user, the combined projection is incident upon the user's eye for providing the visual scene to the user.

Optionally, the at least one optical combiner allows for optically combining the projection of the first image with the projection of the second image in a manner that the projection of the second image is incident upon the fovea of the user's eye, whereas the projection of the first image is incident upon the remaining region of the retina of the user's eye. In other words, the aforesaid optical combination is implemented by the at least one optical combiner in a manner that:
a portion of the combined projection that substantially corresponds to the projection of the second image, is incident upon the fovea of the user's eye, and
a portion of the combined projection that substantially corresponds to the projection of the first image, is incident upon the remaining region of the retina of the user's eye.

Optionally, the at least one optical combiner is implemented by way of at least one of: a lens, a mirror, a semi-transparent mirror, a semi-transparent film, a semi-transparent flexible membrane, a prism, a beam splitter, an optical waveguide, a polarizer.

The at least one optical combiner comprises the first optical element having the reflective surface obliquely facing the at least one exit optical element, the reflective surface having the outwardly-curved shape. It will be appreciated that the reflective surface of the first optical element obliquely faces the at least one exit optical element in a manner that the projection of the second image completely passes through the at least one exit optical element, upon reflection from the reflective surface.

Furthermore, it will be appreciated that the reflective surface of the first optical element (having the outwardly-curved shape) appears to be convex in shape, from the perspective of the user's eye. Therefore, the outwardly-curved shape of the reflective surface allows for shrinking (namely, demagnifying) of an apparent size of the second image, when the second image is viewed by the user. As a result, the apparent resolution of the second image appears to increase substantially, as compared to the second display resolution at which the second image was originally displayed. Notably, the aforesaid apparent shrinking of the second image allows for the apparent angular resolution of the second image to appear as being greater than the apparent angular resolution of the first image. Therefore, irrespective of magnitudes of the first and second display resolutions, the apparent angular resolution of the second image is higher than the apparent angular resolution of the first image, when the first and second images are viewed by the user of the display apparatus. Such apparent angular resolutions of the first and second images allow for the display apparatus to present the image (depicting the visual scene) to the user in a manner that emulates foveation of the human visual system.

In an embodiment, the first optical element is implemented by way of a mirror having the reflective surface, wherein the first optical element is to be arranged in a manner that the projection of the first image and the projection of the second image, when incident upon the reflective surface, reflect from the reflective surface towards the at least one exit optical element. Notably, the mirror is arranged in a manner that the projection of the second image completely passes through the at least one exit optical element, upon reflection from the mirror having the reflective surface. In such a case, the projections of the first and second images emanating from the first and second displays are first incident upon the reflective surface of the first optical element, and are reflected from the reflective surface of the first optical element to be directed towards the at least one exit optical element. Optionally, the mirror having the reflective surface is substantially transmissive, reflective or any combination thereof.

In another embodiment, the reflective surface is semi-transparent, and the first optical element is implemented by way of a lens having the semi-transparent reflective surface and a substantially-transparent surface opposite to the semi-transparent reflective surface, wherein the first optical element is to be arranged in a manner that the projection of the first image enters through the substantially-transparent surface and passes through the semi-transparent reflective surface towards the at least one exit optical element, whilst the projection of the second image reflects from the semi-transparent reflective surface towards the at least one exit optical element. Notably, the semi-transparent reflective surface of the first optical element obliquely faces the at least one exit optical element in a manner that the projection of the second image completely passes through the at least one exit optical element, upon reflection from the semi-transparent reflective surface.

Optionally, the first optical element is arranged in a manner that the substantially-transparent surface obliquely faces the at least one first display. In such a case, the projection of the first image emanating from the at least one first display could be directly incident upon the substantially-transparent surface of the first optical element. Alternatively, optionally, the first optical element is arranged in a manner that the substantially-transparent surface is arranged substantially perpendicularly to the at least one first display. In such a case, the projection of the first image emanating from the at least one first display could be incident upon an additional reflective optical element (such as a mirror), and upon reflection from the additional reflective optical element, be directed towards the substantially-transparent surface of the first optical element.

Optionally, the substantially-transparent surface of the lens has a substantially planar shape. In other words, the substantially-transparent surface of the lens has a substantially flat shape. In such a case, a radius of curvature of the substantially-transparent surface of the lens is approximately infinite. Therefore, the projection of the first image passes through the substantially-transparent surface of the lens with minimal optical distortion.

Alternatively, optionally, the substantially-transparent surface of the lens has an inwardly-curved shape. Beneficially, the inwardly-curved shape of the substantially-transparent surface of the lens complements the apparent convex shape of the semi-transparent reflective surface of the lens, from the perspective of the user's eye. Furthermore, the substantially-transparent surface of the lens having the inwardly-curved shape appears to be concave in shape from a perspective of the first display (and specifically, from a perspective of the projection of the first image), thereby allowing for increasing the apparent size of the first image, when the projection of the first image passes through the first optical element and the at least one exit optical element towards the user's eye.

Optionally, the inwardly-curved shape of the substantially-transparent surface substantially complements the outwardly-curved shape of the semi-transparent reflective surface, such that the thickness of the first optical element is substantially same in at least the central portion of the first optical element. More optionally, the thickness of the first optical element is substantially the same throughout the first optical element.

Optionally, in such a case, a radius of curvature of the substantially-transparent surface is substantially equal to a radius of curvature of the semi-transparent reflective surface, in at least the central portion of the first optical element. It will be appreciated that such an inwardly-curved shape of the substantially-transparent surface allows for preventing and reducing optical distortions within the first image.

In one exemplary implementation, the inwardly-curved shape of the substantially-transparent surface substantially complements the outwardly-curved shape of the semi-transparent reflective surface, such that the thickness of the first optical element is substantially same in only the central portion of the first optical element, and is substantially different in a remaining portion of the first optical element. In such a scenario, the variable thickness of the first optical element allows for improving optical characteristics (for example, such as peripheral appearance) of the first image.

In yet another embodiment, the reflective surface is semi-transparent, and the first optical element is implemented by way of a prism having the semi-transparent reflective surface and a substantially-transparent surface adjacent to the semi-transparent reflective surface, wherein the first optical element is to be arranged in a manner that the projection of the first image enters through the substantially-transparent surface and passes through the semi-transparent reflective surface towards the at least one exit optical element, whilst the projection of the second image reflects from the semi-transparent reflective surface towards the at least one exit optical element. Notably, the first optical element is arranged in a manner that the substantially-transparent surface, which is adjacent to the semi-transparent reflective surface, substantially parallelly faces the at least one first display. In such a case, the projection of the first image emanating from the at least one first display could be directly incident upon the substantially-transparent surface of the first optical element.

Furthermore, the semi-transparent reflective surface of the first optical element obliquely faces the at least one exit optical element in a manner that the projection of the second image completely passes through the at least one exit optical element, upon reflection from the semi-transparent reflective surface.

Optionally, the semi-transparent reflective surface of the first optical element is substantially transmissive, reflective or any combination thereof.

Furthermore, optionally, the substantially-transparent surface of the first optical element is substantially transmissive.

Optionally, the first optical element is implemented by way of at least one of: a lens, a mirror, a semi-transparent mirror, a semi-transparent film, a semi-transparent flexible membrane, a prism, a beam splitter, an optical waveguide.

Optionally, the outwardly-curved shape is selected from the group consisting of: (i) a substantially-spherical shape, (ii) a substantially-parabolic shape and (iii) a freeform shape having asymmetric radii of curvature. Notably, each of the aforesaid shapes allow for shrinking the apparent size of the second image, from the perspective of the user's eye.

In one embodiment, the reflective surface of the first optical element has the substantially-spherical shape. In such a case, the radius of curvature of the reflective surface is substantially-constant (namely, uniform). Optionally, in such a case, a thickness of the first optical element in its central portion is substantially-constant. Beneficially, the reflective surface of the first optical element having the substantially-spherical shape is easy to manufacture.

In another embodiment, the reflective surface of the first optical element has the substantially-parabolic shape. In such a case, the radius of curvature of the reflective surface varies gradiently. Notably, a cross-section of such a parabolic-shaped reflective surface has an oval shape, thereby allowing for reducing optical and geometric distortions within the projection of the first and second images. Additionally, optionally, the reflective surface having the substantially-parabolic shape allows for reduction in geometric dimensions of the display apparatus.

In yet another embodiment, the reflective surface of the first optical element has the freeform shape having asymmetric radii of curvature. Notably, the freeform shape may be a combination of flat and curved surfaces on the reflective surface of the first optical element. The asymmetric radii of curvature account for the freeform shape of the reflective surface. Furthermore, at least the central portion of the freeform-shaped reflective surface is convex, thereby allowing for shrinking the apparent size of the projection of the second image. Notably, the thickness of the first optical element in its central portion could be either constant or variable. When the thickness of the first optical element in its central portion is variable, the freeform-shaped reflective surface of the first optical element allows for substantially improving optical and geometric characteristics of the first image. Beneficially, optionally, the freeform-shaped reflective surface allows for substantial reduction in geometric dimensions of the display apparatus.

Optionally, a curvature of the reflective surface of the first optical element is dynamically changeable. Optionally, in this regard, the first optical element is made using an active polymer or a flexible membrane. Such an active polymer or a flexible membrane is controllable by a given drive signal, for example, such as a voltage signal. Furthermore, such active polymers can be amorphous, elastomeric, semi-crystalline, or liquid crystalline, and can be activated in response to heat, light, and/or an electrical field. Optionally, the active polymer or the flexible membrane is actuated by the given signal to change the shape of the reflective surface of the first optical element. Beneficially, the dynamically-changeable curvature of the reflective surface of the first optical element provides a flexible and economically efficient way of adjusting the field of view of the second image thereof. Optionally, the outwardly-curved shape has at least one radii of curvature ranging between 40 mm and 500 mm. In such a case, the outwardly-curved shape may have at least one radii of curvature equal to 40, 50, 60, 70, 80, 90, 100, 120, 140, 160, 180, 200, 220, 240, 260, 280, 300, 320, 340, 360, 380, 400, 420, 440, 460, 480, or 500 mm. Notably, such at least one radii of curvature of the outwardly-curved shape (of the reflective element) affect a horizontal field of view (namely, a horizontal viewing angle) of the second image. The horizontal field of view of a given image can be understood to be an angular width of a projection of the given image. Therefore, the aforesaid at least one radii of curvature affect the angular width of the projection of the second image. As an example, when the outwardly-curved shape has at least one radii of curvature equal to 500 mm, a horizontal field of view of the second image may be approximately 45 degrees.

Alternatively, optionally, the outwardly-curved shape has at least one radii of curvature greater than 500 mm. Optionally, in such a case, the outwardly-curved shape has at least one radii of curvature ranging between 500 mm and 700 mm. As an example, the outwardly-curved shape may have the at least one radii of curvature equal to 520, 540, 560, 580, 600, 620, 640, 660, 680 or 700 mm. As an example, when the outwardly-curved shape has at least one radii of curvature equal to 700 mm, a horizontal field of view of the second image may be approximately 50 degrees.

Optionally, the at least one optical combiner further comprises a second optical element having a reflective surface, the first optical element and the second optical element are to be arranged on the optical path of the projection of the second image in a manner that the projection of the second image, when incident upon the reflective surface of the second optical element is reflected towards the reflective surface of the first optical element, and is then reflected from the reflective surface of the first optical element towards the at least one exit optical element.

When the first optical element is implemented by way of the aforementioned lens, the projection of the second image emanating from the at least one second display may pass through both the substantially-transparent surface and the semi-transparent reflective surface of the lens, to be incident upon the reflective surface of the second optical element. In such a case, the reflective surface of the second optical element is arranged to parallelly face, or obliquely face, or be substantially perpendicular to the semi-transparent reflective surface of the lens.

In an embodiment, the reflective surface of the second optical element has a substantially-planar shape. In another embodiment, the reflective surface of the second optical element has a substantially-curved shape. In yet another embodiment, the reflective surface of the second optical element has a freeform shape.

Optionally, the second optical element is implemented by way of at least one of: a semi-transparent mirror, a semi-transparent film, a fully reflective mirror, a fold curved mirror, a beam splitter, a prism, a lens, an optical waveguide.

It will be appreciated that the at least one optical combiner is a complex optical component, and is not limited to including only the first optical element, and optionally, the second optical element. The at least one optical combiner could include additional optical elements, such as a third optical element, a fourth optical element, and so forth, for adjusting optical path and/or optical characteristics of the projection of the first image and/or the projection of the second image, thereby performing the aforesaid optical combination of the projections of the first and second images in a proper manner.

Optionally, the length of the optical path from the at least one second display to the user's eye, when the display apparatus in operation is worn by the user, ranges between 25 mm and 300 mm. The term “optical path” used herein relates to an optical trajectory travelled by the projection of the second image from the at least one second display to the user's eye, when the display apparatus in operation is worn by the user. Therefore, the “length of the optical path” from the at least one second display to the user's eye relates to an optical distance travelled along the optical trajectory, by the projection of the second image from the at least one second display to the user's eye.

In an example, the first optical element of the at least one optical combiner may be arranged such that the projection of the second image (emanating from the at least one second display) is reflected from the reflective surface of the first optical element towards the at least one exit optical element. In such a case, the length of the optical path from the at least one second display to the user's eye may be, for example, approximately 73 mm.

In another example, the first and second optical elements of the at least one optical combiner may be arranged such that the projection of the second image passes through the first optical element towards the reflective surface of the second optical element, from where the projection of the second image is reflected towards the reflective surface of the first optical element, and is then reflected from the reflective surface of the first optical element towards the at least one exit optical element. In such a case, the length of the optical path from the at least one second display to the user's eye may be, for example, approximately 125 mm.

It will be appreciated that the length of the optical path from the at least one second display to the user's eye has a direct relationship with the size of the display apparatus. Notably, greater the length of the aforesaid optical path, greater is the size of the display apparatus. Therefore, when the length of the aforesaid optical path is less, the arrangement of the optical elements within the display apparatus is compact, and the size of the display apparatus will be small.

Optionally, positions of the at least one first display, the at least one second display and the at least one optical combiner are fixed. It will be appreciated that the aforesaid fixed arrangement of the at least one first display, the at least one second display and the at least one optical combiner, allows for providing fixed optical paths of the projection of the first image and the projection of the second image. Optionally, in such a case, the length of the optical path from the at least one second display to the user's eye is fixed. It will be appreciated that the aforesaid fixed arrangement of the at least one first display, the at least one second display and the at least one optical combiner may be employed in the case when the second image substantially corresponds to the central portion of the image depicting the visual scene whereas the first image substantially corresponds to the peripheral portion of the image depicting the visual scene. In such a case, the aforesaid fixed arrangement may allow for directing the projection of the second image towards the fovea of the user's eye whilst directing the projection of the first image towards the remaining region of the retina of the user's eye. As a result, the aforesaid fixed arrangement substantially emulates foveation of the human visual system since the user's gaze is typically known to be focused towards the central portion of the visual scene.

Optionally, a position of at least one of: the at least one first display, the at least one second display, the at least one optical combiner is adjustable. Optionally, in this regard, the display apparatus further comprises at least one actuator that is to be employed to adjust the position of at least one of: the at least one first display, the at least one second display, the at least one optical combiner. Notably, the position of at least one of: the at least one first display, the at least one second display and/or the at least one optical combiner may be adjusted, to subsequently adjust the optical path of the projection of the first image and/or the optical path of the projection of the second image. Beneficially, such adjustment of the optical path of the projection of the first image and/or the optical path of the projection of the second image allows the display apparatus to emulate foveation of the human visual system according to the user's gaze.

Optionally, the display apparatus further comprises a processor coupled to the at least one first display and the at least one second display, wherein the processor is configured to display the first image and the second image, via the at least one first display and the at least one second display, substantially simultaneously. In an embodiment, the processor is implemented by way of hardware, software, firmware or a combination of these, suitable for controlling the operation of the display apparatus. Notably, displaying the first image and the second image substantially simultaneously allows for presenting the image of the visual scene to the user as a whole, in a manner that the user views the complete visual scene at a given time instant, rather than as two separate portions of the visual scene at separate time instants.

Optionally, the processor is configured to obtain the first image and the second image from an external computing device (for example, such as a smartphone or an external imaging system) coupled in communication with the processor. In one scenario, the processor directly obtains the first image and the second image from the external computing device. In another scenario, the processor obtains an input image from the external computing device, and processes the input image to generate the first image and the second image. Notably, the term “input image” relates to the image depicting the visual scene. In an implementation, the external computing device, for example such as a camera, is implemented on (namely, mounted on) the display apparatus. In such a case, the external computing device is configured to capture an image of a given real-world environment whereat the user is physically present. Such a captured image is the input image wherefrom the first image and the second image are to be generated, either by the external computing device, or by the processor. In another implementation, the external computing device is integrated with a remote device. In such a case, the external computing device is mounted on the remote device, and therefore, is remote to the display apparatus. Furthermore, in such a case, the remote device may be positioned within the given real-world environment, whereas the user of the display apparatus may be positioned away from the remote device. Optionally, the remote device is one of: a drone, a robot.

Alternatively, optionally, processor is configured to obtain the first image and the second image from an imaging system of the display apparatus. In such a case, the processor may obtain the input image from the imaging system.

Yet alternatively, optionally, the processor is configured to digitally generate the first image and the second image.

Optionally, the first image and the second image are to be generated based upon a gaze direction of the user. Optionally, in this regard, the display apparatus further comprises means for detecting a gaze direction coupled in communication with the processor, wherein the means for detecting the gaze direction is configured to communicate the detected gaze direction of the user to the processor, and the processor is configured to process the input image to generate the first image and the second image, based upon the detected gaze direction.

Optionally, the processor is configured to perform at least one digital image processing operation on the first image and/or the second image, to accommodate for optical distortions (for example, such as geometric distortion, chromatic distortion, and the like) that may be introduced within the first image and/or the second image whilst the projection of the first image and the projection of the second image are optically combined by the at least one optical combiner. Optionally, in this regard, the at least one digital image processing operation is selected from the group consisting of: low pass filtering, image cropping, image sharpening, colour processing, gamma correction, and edge processing.

The present disclosure also relates to the method as described above. Various embodiments and variants disclosed above apply mutatis mutandis to the method.

Optionally, the method further comprises dynamically changing a curvature of the reflective surface of the first optical element.

Optionally, the method further comprises adjusting the position of at least one of: the at least one first display, the at least one second display, the at least one optical combiner.

### DETAILED DESCRIPTION OF THE DRAWINGS

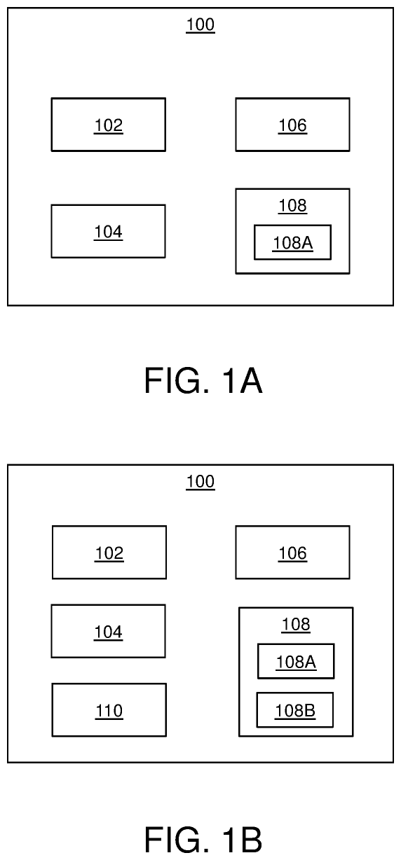

Referring to FIGS. 1A and 1B, illustrated are block diagrams of architectures of a display apparatus 100, in accordance with different embodiments of the present disclosure. It may be understood by a person skilled in the art that FIGS. 1A and 1B include simplified architectures of the display apparatus 100 for the sake of clarity, which should not unduly limit the scope of the claims herein. The person skilled in the art will recognize many variations, alternatives, and modifications of embodiments of the present disclosure.

As shown in FIGS. 1A and 1B, the display apparatus 100 comprises at least one first display 102 having a first display resolution, at least one second display 104 having a second display resolution, at least one exit optical element 106, and at least one optical combiner 108. Notably, the at least one first display 102 is to be employed for displaying a first image, whereas the at least one second display 104 is to be employed for displaying a second image. The optical combiner 108 is to be employed to optically combine a projection of the first image with a projection of the second image.

The at least one optical combiner 108 comprises a first optical element 108A having a reflective surface obliquely facing the at least one exit optical element 106.

As shown in FIG. 1B, the at least one optical combiner 108 further comprises a second optical element 108B having a reflective surface. The display apparatus 100 further comprises a processor 110 coupled to the at least one first display 102 and the at least one second display 104. The processor 110 is configured to display the first image and the second image, via the at least one first display 102 and the at least one second display 104, substantially simultaneously.

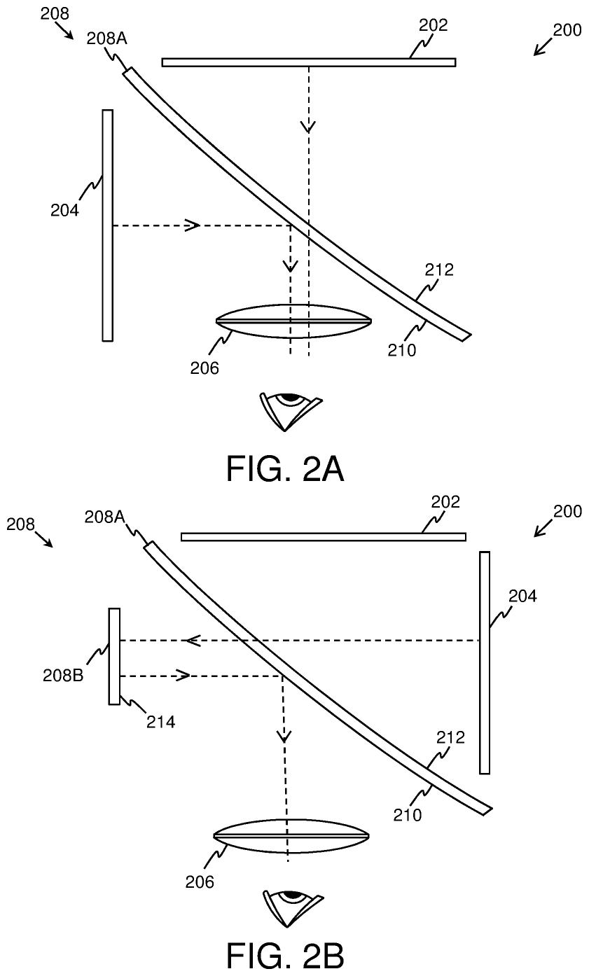

Referring to FIGS. 2A and 2B, illustrated are exemplary implementations of a display apparatus 200, in accordance with different embodiments of the present disclosure. It may be understood by a person skilled in the art that FIGS. 2A and 2B include simplified arrangements for implementation of the display apparatus 200 for the sake of clarity, which should not unduly limit the scope of the claims herein. The person skilled in the art will recognize many variations, alternatives, and modifications of embodiments of the present disclosure.

As shown in FIGS. 2A and 2B, the display apparatus 200 comprises at least one first display (depicted as a first display 202), at least one second display (depicted as a second display 204), at least one exit optical element (depicted as an exit optical element 206), and at least one optical combiner (depicted as an optical combiner 208). The first display 202 has a first display resolution and is to be employed for displaying a first image. The second display 204 has a second display resolution and is to be employed for displaying a second image. The optical combiner 208 is to be employed to optically combine a projection of the first image with a projection of the second image.

As shown, the optical combiner 208 comprises a first optical element 208A having a reflective surface 210 obliquely facing the exit optical element 206. With reference to FIGS. 1A and 1B, the reflective surface 210 is semi-transparent, and the first optical element 208A is implemented by way of a lens having the semi-transparent reflective surface 210 and a substantially-transparent surface 212 opposite to the semi-transparent reflective surface 210. Furthermore, the semi-transparent reflective surface 210 has an outwardly-curved shape.

In some exemplary implementations, the size of the first display 202 and/or the second display 204 may range between 1.4 inch and 4 inch, when measured diagonally. Moreover, the length of an optical path from the second display 204 to a user's eye, when the display apparatus 200 in operation is worn by the user, may range between 25 mm and 300 mm.

In FIG. 2A, the first optical element 208A is arranged in a manner that the projection of the first image enters through the substantially-transparent surface 212 and passes through the semi-transparent reflective surface 210 towards the exit optical element 206, whilst the projection of the second image reflects from the semi-transparent reflective surface 210 towards the exit optical element 206. In such an exemplary implementation, the length of the optical path from the second display 204 to the user's eye, when the display apparatus 200 in operation is worn by the user, is, for example, approximately 70 mm.

In FIG. 2B, the optical combiner 208 further comprises a second optical element 208B having a reflective surface 214. As shown, the first optical element 208A and the second optical element 208B are arranged on an optical path of the projection of the second image in a manner that the projection of the second image emanating from the second display 204 passes through the first optical element 208A towards the reflective surface 214 of the second optical element 208B, from where the projection of the second image is reflected towards the semi-transparent reflective surface 210 of the first optical element 208A, and is then reflected from the semi-transparent reflective surface 210 towards the exit optical element 206. Furthermore, the projection of the first image enters the first optical element 208A through the substantially-transparent surface 212 and passes through the semi-transparent reflective surface 210 towards the exit optical element 206. As an example, the second optical element 208B may be a fold curved mirror. In such an exemplary implementation, the length of the optical path from the second display 204 to the user's eye, when the display apparatus 200 in operation is worn by the user, is, for example, approximately 225 mm.

Referring to FIG. 2C, illustrated is an isometric view of the first optical element 208A of the optical combiner 208, in accordance with an embodiment of the present disclosure. As shown, the semi-transparent reflective surface 210 has an outwardly-curved shape and the substantially-transparent surface 212 has an inwardly-curved shape.

It may be understood by a person skilled in the art that FIG. 2C includes simplified view of the optical combiner 208 for the sake of clarity only, which should not unduly limit the scope of the claims herein. The person skilled in the art will recognize many variations, alternatives, and modifications of embodiments of the present disclosure.

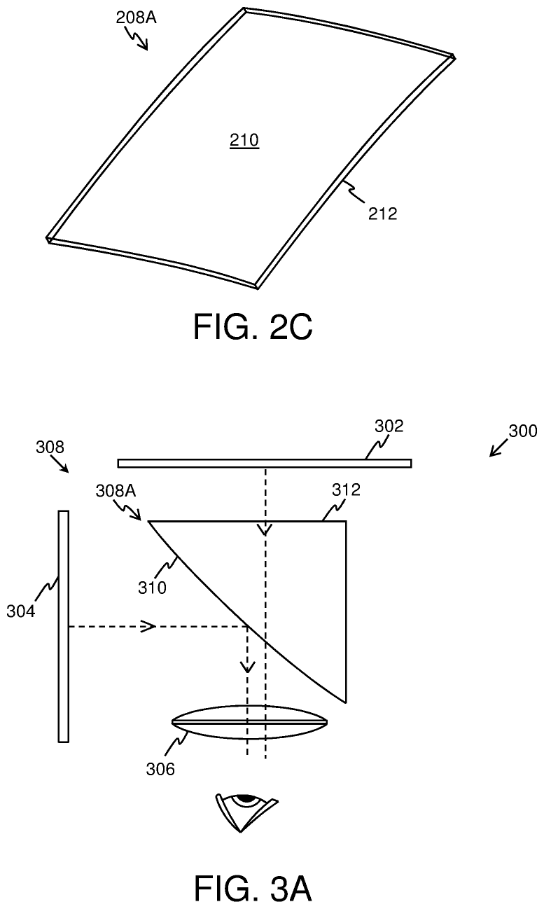

Referring to FIGS. 3A and 3B, illustrated are exemplary implementations of a display apparatus 300, in accordance with different embodiments of the present disclosure. It may be understood by a person skilled in the art that FIGS. 3A and 3B include simplified arrangements for implementation of the display apparatus 300 for the sake of clarity, which should not unduly limit the scope of the claims herein. The person skilled in the art will recognize many variations, alternatives, and modifications of embodiments of the present disclosure.

As shown in FIGS. 3A and 3B, the display apparatus 300 comprises at least one first display (depicted as a first display 302), at least one second display (depicted as a second display 304), at least one exit optical element (depicted as an exit optical element 306) and at least one optical combiner (depicted as an optical combiner 308). The first display 302 has a first display resolution and is to be employed for displaying a first image. The second display 304 has a second display resolution and is to be employed for displaying a second image. The optical combiner 308 is to be employed to optically combine a projection of the first image with a projection of the second image. As shown, the optical combiner 308 comprises a first optical element 308A having a reflective surface 310 obliquely facing the exit optical element 306. The reflective surface 310 is semi-transparent, and the first optical element 308A is implemented by way of a prism having the semi-transparent reflective surface 310 and a substantially-transparent surface 312 adjacent to the semi-transparent reflective surface 310. Furthermore, the semi-transparent reflective surface 310 has an outwardly-curved shape.

In FIG. 3A, the first optical element 308A is arranged in a manner that the projection of the first image enters through the substantially-transparent surface 312 and passes through the semi-transparent reflective surface 310 towards the exit optical element 306, whilst the projection of the second image reflects from the semi-transparent reflective surface 310 towards the exit optical element 306.

In FIG. 3B, the optical combiner 308 further comprises a second optical element 308B having a reflective surface 314. As shown, the first optical element 308A and the second optical element 308B are arranged on an optical path of the projection of the second image in a manner that the projection of the second image, when incident upon the reflective surface 314 of the second optical element 308B, is reflected towards the semi-transparent reflective surface 310 of the first optical element 308A, and is then reflected from the semi-transparent reflective surface 310 towards the exit optical element 306.

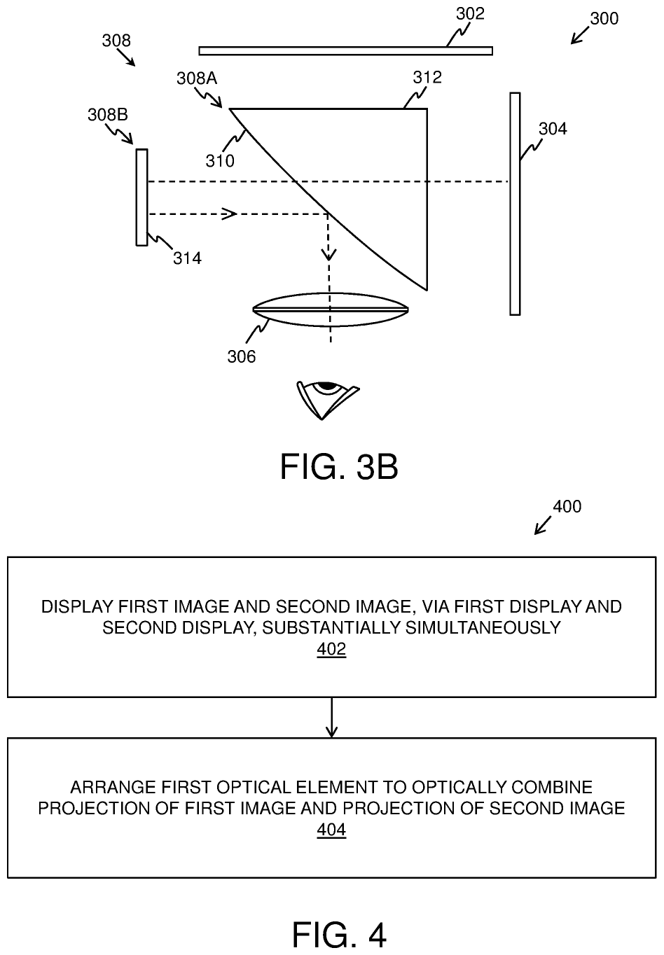

Referring to FIG. 4, illustrated are steps of a method 400 of displaying, via a display apparatus, in accordance with an embodiment of the present disclosure. In the method 400 of displaying, the display apparatus comprises at least one first display having a first display resolution, at least one second display having a second display resolution, at least one exit optical element and at least one optical combiner, wherein the at least one optical combiner comprises a first optical element having a reflective surface obliquely facing the at least one exit optical element, the reflective surface having an outwardly-curved shape.

At step 402, a first image and a second image are displayed via the at least one first display and the at least one second display, substantially simultaneously. At step 404, the first optical element is arranged in a manner that a projection of the first image and a projection of the second image are optically combined.

The steps 402 to 404 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A display apparatus comprising:
at least one first display having a first display resolution, wherein the at least one first display is to be employed for displaying a first image;
at least one second display having a second display resolution, wherein the at least one second display is to be employed for displaying a second image;
at least one exit optical element; and
at least one optical combiner to be employed to optically combine a projection of the first image with a projection of the second image, the at least one optical combiner comprising a first optical element having a reflective surface obliquely facing the at least one exit optical element, the reflective surface having an outwardly-curved shape.

2. The display apparatus of claim 1, wherein the first optical element is implemented by way of a mirror having the reflective surface, wherein the first optical element is to be arranged in a manner that the projection of the first image and the projection of the second image, when incident upon the reflective surface, reflect from the reflective surface towards the at least one exit optical element.

3. The display apparatus of claim 1, wherein the reflective surface is semi-transparent, and the first optical element is implemented by way of a lens having the semi-transparent reflective surface and a substantially-transparent surface opposite to the semi-transparent reflective surface,
wherein the first optical element is to be arranged in a manner that the projection of the first image enters through the substantially-transparent surface and passes through the semi-transparent reflective surface towards the at least one exit optical element, whilst the projection of the second image reflects from the semi-transparent reflective surface towards the at least one exit optical element.

4. The display apparatus of claim 3, wherein the substantially-transparent surface of the lens has a substantially planar shape.

5. The display apparatus of claim 3, wherein the substantially-transparent surface of the lens has an inwardly-curved shape.

6. The display apparatus of claim 5, wherein the inwardly-curved shape of the substantially-transparent surface substantially complements the outwardly-curved shape of the semi-transparent reflective surface, such that a thickness of the first optical element is substantially same in at least a central portion of the first optical element.

7. The display apparatus of claim 1, wherein the reflective surface is semi-transparent, and the first optical element is implemented by way of a prism having the semi-transparent reflective surface and a substantially-transparent surface adjacent to the semi-transparent reflective surface,
wherein the first optical element is to be arranged in a manner that the projection of the first image enters through the substantially-transparent surface and passes through the semi-transparent reflective surface towards the at least one exit optical element, whilst the projection of the second image reflects from the semi-transparent reflective surface towards the at least one exit optical element.

8. The display apparatus of claim 1, wherein the outwardly-curved shape is selected from the group consisting of: (i) a substantially-spherical shape, (ii) a substantially-parabolic shape and (iii) a freeform shape having asymmetric radii of curvature.

9. The display apparatus of claim 1, wherein a curvature of the reflective surface of the first optical element is dynamically changeable.

10. The display apparatus of claim 1, wherein the outwardly-curved shape has at least one radii of curvature ranging between 40 mm and 500 mm.

11. The display apparatus of claim 1, wherein the size of the at least one first display is substantially similar to the size of the at least one second display.

12. The display apparatus of claim 1, wherein the size of the at least one first display and/or the at least one second display ranges between 1.4 inch and 4 inch, when measured diagonally.

13. The display apparatus of claim 1, wherein the length of an optical path from the at least one second display to a user's eye, when the display apparatus in operation is worn by the user, ranges between 25 mm and 300 mm.

14. The display apparatus of claim 1, wherein the at least one optical combiner further comprises a second optical element having a reflective surface, the first optical element and the second optical element are to be arranged on an optical path of the projection of the second image in a manner that the projection of the second image, when incident upon the reflective surface of the second optical element, is reflected towards the reflective surface of the first optical element, and is then reflected from the reflective surface of the first optical element towards the at least one exit optical element.

15. The display apparatus of claim 1, wherein positions of the at least one first display, the at least one second display and the at least one optical combiner are fixed.

16. The display apparatus of claim 1, wherein a position of at least one of: the at least one first display, the at least one second display, the at least one optical combiner is adjustable.

17. The display apparatus of claim 1, further comprising a processor coupled to the at least one first display and the at least one second display, wherein the processor is configured to display the first image and the second image, via the at least one first display and the at least one second display, substantially simultaneously.

18. A method of displaying, via a display apparatus comprising at least one first display having a first display resolution, at least one second display having a second display resolution, at least one exit optical element and at least one optical combiner, the at least one optical combiner comprising a first optical element having a reflective surface obliquely facing the at least one exit optical element, the reflective surface having an outwardly-curved shape, the method comprising:
displaying a first image and a second image, via the at least one first display and the at least one second display, substantially simultaneously; and
arranging the first optical element in a manner that a projection of the first image and a projection of the second image are optically combined.

19. The method of claim 18, further comprising dynamically changing a curvature of the reflective surface of the first optical element.

20. The method of claim 18, further comprising adjusting a position of at least one of: the at least one first display, the at least one second display, the at least one optical combiner.
